(19) United States
(12) Patent Application Publication
(10) Pub. No.: US 2026/0143356 A1
(43) Pub. Date: May 21, 2026

(54) SCHEDULING RESTRICTION SKIPPING INDICATION

(71) Applicant: QUALCOMM Incorporated, San Diego, CA (US)

(72) Inventors: Jae Ho RYU, San Diego, CA (US); Huilin XU, Beijing (CN); Prashant SHARMA, San Marcos, CA (US)

(21) Appl. No.: 19/393,517

(22) Filed: Nov. 18, 2025

Related U.S. Application Data
(60) Provisional application No. 63/722,921, filed on Nov. 20, 2024.

(51) Int. Cl. H04W 24/02; H04W 72/232

(52) U.S. Cl. CPC H04W 24/02; H04W 72/232

(57) ABSTRACT

Certain aspects of the present disclosure provide techniques for scheduling restriction skipping indication. An example method, performed at a wireless node, generally includes obtaining first signaling configuring the wireless node with scheduling restrictions associated with one or more serving cells, obtaining second signaling that conveys an indication that the wireless node is to skip at least one of the scheduling restrictions, and skipping applying at least one of the scheduling restrictions in at least one of the serving cells, in accordance with the indication.

### CROSS-REFERENCE TO RELATED APPLICATIONS

The present patent application claims the benefit of and priority to U.S. Provisional Ser. No. 63/722,921, filed on Nov. 20, 2024, which is hereby expressly incorporated by reference in its entirety.

### FIELD OF THE DISCLOSURE

Aspects of the present disclosure relate to wireless communications, and more particularly, to techniques for indicating scheduling restrictions to be skipped.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication at a wireless node. The method includes obtaining first signaling configuring the wireless node with scheduling restrictions associated with one or more serving cells; obtaining second signaling that conveys an indication that the wireless node is to skip at least one of the scheduling restrictions; and skipping applying at least one of the scheduling restrictions in at least one of the serving cells, in accordance with the indication.

Another aspect provides a method for wireless communication at a first wireless node. The method includes outputting first signaling configuring a second wireless node with scheduling restrictions associated with one or more serving cells; and outputting second signaling that conveys an indication that the wireless node is to skip at least one of the scheduling restrictions.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts examples of measurement gaps and their impact on extended reality (XR) traffic.

FIG. 6 depicts an example of measurement gap skipping.

FIG. 7 depicts an example call flow diagram, in accordance with certain aspects of the present disclosure.

FIG. 8 depicts a method for wireless communications.

FIG. 9 depicts a method for wireless communications.

FIG. 10 depicts aspects of an example communications device.

### DETAILED DESCRIPTION

Aspects of the present disclosure provide apparatuses, methods, processing systems, and computer-readable mediums for indicating scheduling restrictions to be skipped.

A scheduling restriction may involve, for example, a restriction on scheduling certain types of transmissions during certain time periods. For example, a scheduling restriction may involve a constraint on scheduling physical downlink shared channel (PDSCH) transmissions during time periods (referred to as measurement gaps or MGs) configured for a user equipment (UE) to measure synchronization signal blocks (SSBs) from one or more cells. To ensure good radio conditions, the network may configure MGs, for the UE to perform inter-frequency or inter radio access technology (inter-RAT) measurement, beam measurement, and/or intra-frequency measurement.

In some cases, scheduling restrictions (such as MGs) may be skipped, effectively allowing the restrictions to be lifted. For example, if transmission or reception is prohibited in a MG, skipping the MG may remove this prohibition and help improve performance. Measurement gap skipping may be indicated dynamically via downlink control information (DCI).

Unfortunately, there are various challenges with such DCI-based dynamic measurement gap skipping indication. For example, the skipping indication may be conveyed via a single bit in DCI limiting the flexibility in what is skipped. For example, the skipping may be applied (skip) the first MG or other type of scheduling restriction (SR) after a minimum time offset. When multiple measurement gaps and/or other types of scheduling restrictions are configured, there may be some ambiguity in which measurement gap or scheduling restriction is to be skipped.

Aspects of the present disclosure, however, provide mechanisms that may help remove such ambiguity. For example, in scenarios where multiple scheduling restrictions are configured, the mechanisms proposed herein may help a UE and network entity be in agreement on which of the multiple scheduling restrictions are to be skipped. As a result, aspects of the present disclosure may help provide flexibility, improve resource utilization, and improve overall performance.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

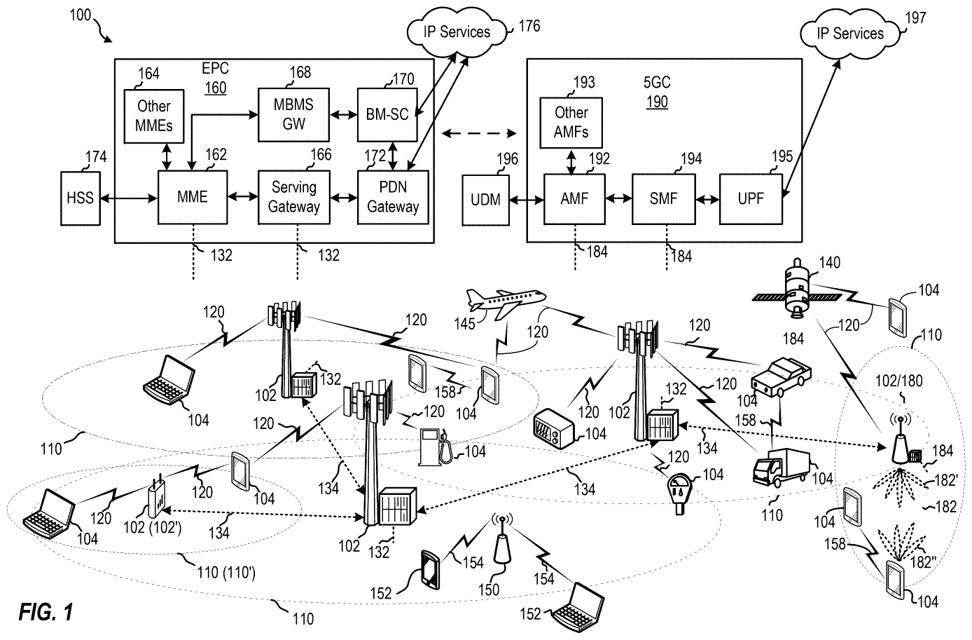

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

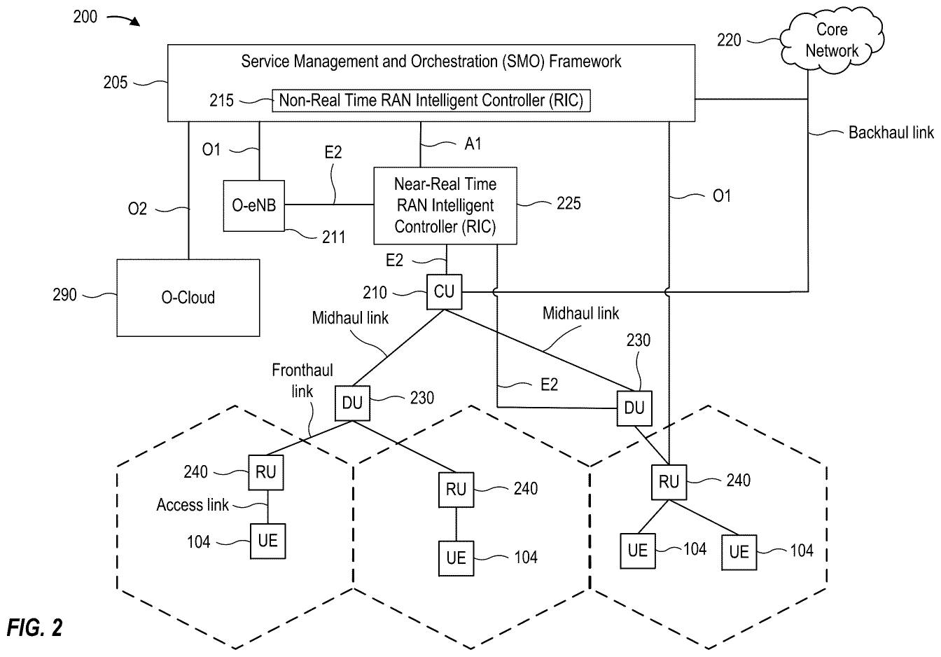

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1 ) as including 410 MHz-7125 MHz, which is often referred to (interchangeably) as “Sub-6 GHz”. Similarly, 3GPP currently defines Frequency Range 2 (FR2 ) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182″. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

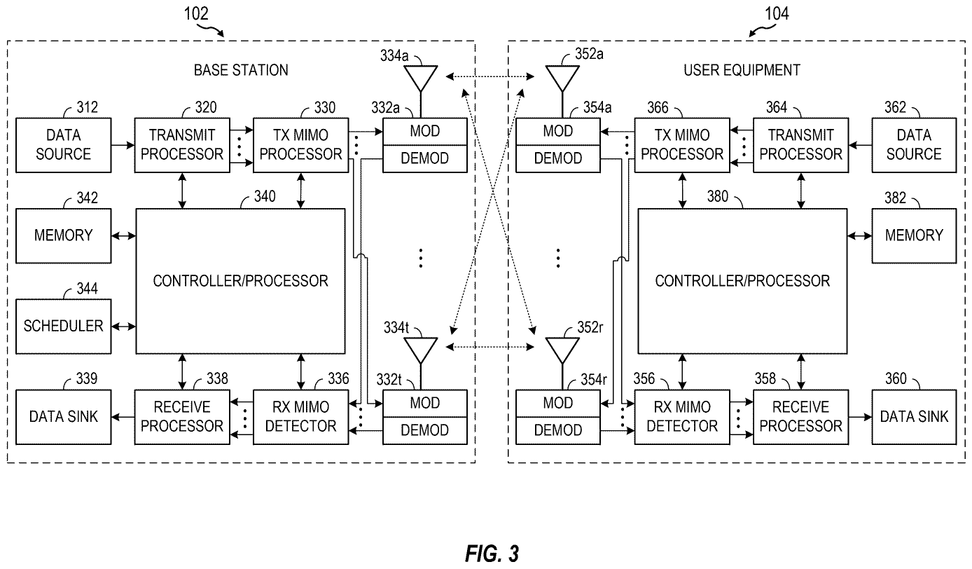

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, down-convert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

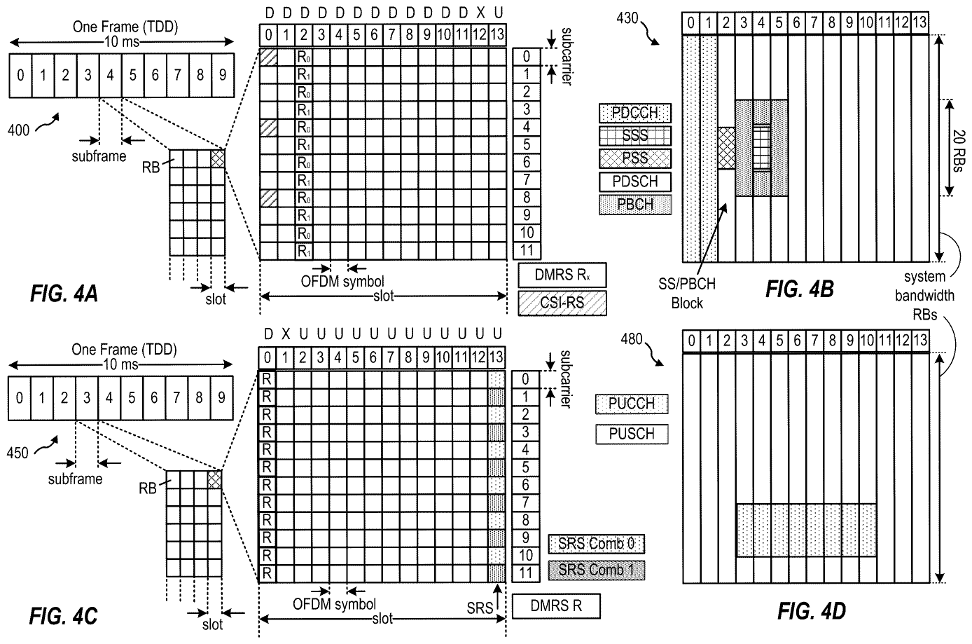

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μslots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Measurement Gaps

To ensure good radio conditions, the network may configure time periods, referred to as measurement gaps (MGs), for the UE to perform inter-frequency or inter radio access technology (inter-RAT) measurement, beam measurement, and/or intra-frequency measurement when a UE's active bandwidth part (BWP) does not contain a synchronization signal block (SSB).

When a UE is configured to periodically and/or aperiodically measure and/or decode SSBs of neighboring cells, the UE typically expects to obtain various kinds of information in MGs, depending on a particular case. According to a first case, the UE is expected to obtain a metric indicative of signal strength of neighboring cells, such as RSRP and/or RS received quality (RSRQ). According to a second case, the UE is expected to obtain basic information of neighbor cells, such as a cell global identifier (CGI).

For the first case, the UE does not need to decode the SSB from neighbor cells, since it just acquires signal strength, which may be obtained relatively quickly as the SSB does not need to be decoded. The UE conducts measurement in a configured MG, in which the UE is not expected to receive on the downlink (e.g., PDCCH or PDSCH) or to transmit on the uplink (e.g., PUCCH, SRS, PUSCH), except for physical random access channel (PRACH) transmissions. For the second case, the UE decodes SSB of neighbor cells, in order to obtain master information block (MIB) information and/or system information block (SIB) information, in which the UE can obtain the CGI. A relatively long time may be required to accomplish this decoding, which may be longer than the configured MG length, particularly for UEs with relatively low processing capability.

### Overview of Measurement Gap and Traffic Collisions

In some cases, dynamic adaptation of measurement gaps may be utilized. With dynamic adaptation, the network may indicate that the UE is to switch between one mode where the UE performs more measurement operations and another mode where the UE performs more data communication, which could occupy the resource allocated for measurement gaps. In this manner, dynamic adaptation of measurement gaps may provide flexibility in whether the UE is allowed to communicate with gNB for a data channel. The network may make decisions depending on channel condition, available bandwidth, and remaining delay budget.

Unfortunately, measurement gap periodicity is typically limited to a certain set of available periodicities and cannot be arbitrarily configured to match with the XR data periodicity. For example, measurement gap periodicities (20, 40, 80, 160 ms) may be designed to match with an SSB-based RRM Measurement Timing Configuration (SMTC) window/SSB periodicities. XR traffic has a typical frame rate of 30, 45, 60, 90 and 120 frames per second which corresponds to a frame periodicity of 33.33, 22.22, 16.66, 11.11, 8.33 ms. Collision between measurement gaps and XR traffic may be not be easily avoided only by adjusting the offset of a measurement gap or the offset of the XR data.

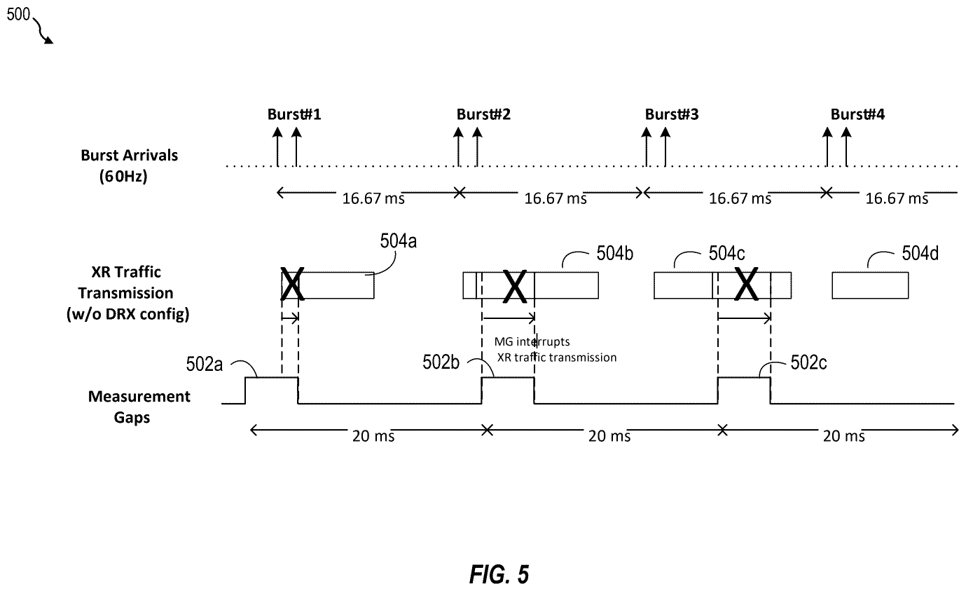

This issue is illustrated in diagram 500 of FIG. 5, which shows the potential impact when measurement gaps are placed within the transmission periods for burst traffic. As noted above, it may not be possible to align the measurement gap periodicity (e.g., 20/40/80/160 ms) with the periodicity of multimedia traffic or enhanced Connected-mode Discontinuous Reception (eCDRX) periods. Thus, the conflict between overlapping measurement gaps and multimedia traffic transmission cannot be avoided by simply adjusting the offset values due to drift. Because the measurement gap typically has a higher priority than the normal data traffic in current systems, the UE may be unable to receive any traffic data (e.g., PDSCH) from the gNB during the measurement gap and its preparation time. Thus, the measurement gap increases the transmission time for burst traffic, making it difficult to meet the PDB requirements of multimedia traffic.

In the illustrated example, burst traffic (e.g., multimedia burst traffic #1- #4) arrives at a network entity (e.g., gNB) at a 60 Hz cadence (every 16.67 ms). The burst traffic is delivered to a UE in PDSCH transmissions 504. In the illustrated example, measurement gaps 502 are configured to occur periodically (i.e., every 40 ms) and overlap with the PDSCH transmissions 504, resulting in an increase in transmission time of some of the burst traffic.

For example, measurement gap 502a overlaps with PDSCH transmission 504a used to transmit a first traffic burst, Burst Traffic #1. The overlap is indicated by the “X” and causes a delay in the start of the transmission of the burst traffic until after the end of the measurement gap 502a. Similarly, measurement gap 502b overlaps with a PDSCH transmission period 504b, while measurement gap 502c overlaps with a PDSCH transmission period 504c, causing an increase in transmission time of Burst Traffic #2 and Burst Traffic #3. On the other hand, because PDSCH transmission period 504d does not overlap with any measurement gap, it may have a shorter duration and delivery of Burst Traffic #4 may be more likely to stay within its PDB.

Delivery of multimedia delay traffic may be further delayed when a UE is configured for both a measurement gap feature and eCDRX operation. This is because the inactivity timer may expire during the measurement gap, which may cause the UE to enter the inactive state (e.g., “sleep” mode) for the remainder of the eCDRX cycle. The remaining data burst of traffic may be delayed until the start of the next eCDRX cycle, which may cause the PDB requirements of the multimedia traffic to not be met.

### Aspects Related to Scheduling Restriction Skipping Indication

Aspects of the present disclosure provide apparatuses, methods, processing systems, and computer-readable mediums for indicating scheduling restrictions to be skipped.

As noted above, a scheduling restriction may involve a restriction on scheduling certain types of transmissions during certain time periods. Examples of scheduling restrictions involve measurement gaps (MGs), such as a prohibition on scheduling PDSCH transmissions during MGs.

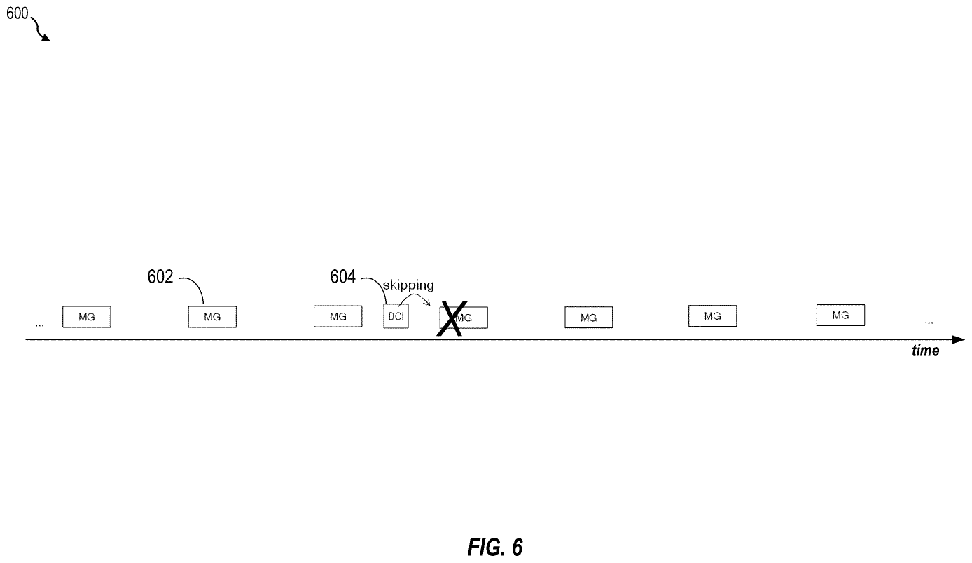

As illustrated in diagram 600 of FIG. 6, in some cases scheduling restrictions (such as MGs 602) may be skipped. For example, MG skipping may be indicated dynamically via downlink control information (DCI) 604. In some cases, the skipping indication may be conveyed via a single bit in DCI limiting the flexibility in what is skipped. For example, based on the bit, the skipping may be applied to skip the first MG after a minimum time offset.

In addition to (or as an alternative to), skipping may also be applied to other types of scheduling restrictions (SRs), such as PDSCH scheduling restrictions in certain frequency ranges (e.g., FR 2). In some cases, a UE may be configured to perform layer 3 (L3) measurements within a synchronization signal block (SSB)-based radio resource management (RRM) Measurement Timing Configuration (SMTC) window. In such cases, a network entity (e.g., gNB) may be prohibited from scheduling PDSCH to an FR2 UE, within an SMTC duration. This SR may be imposed, for example, because the UE may be supposed to perform intra-frequency neighbor cell measurement with a non-serving UE receive (Rx) beam. Aspects of the present disclosure may provide mechanisms to support DCI-based measurement gap skipping applied to PDSCH scheduling restriction within SMTC.

In some cases, a UE may be configured to perform layer 1 (L1 ) measurement outside an SMTC. In such cases, outside an SMTC window, a gNB may be prohibited from scheduling PDSCH to a FR2 UE during SSB symbols. This SR may be imposed, for example, because the UE may be supposed to perform L1 reference signal received power (RSRP) measurement for gNB/UE beam refinement. Aspects of the present disclosure may provide mechanisms to support DCI-based measurement gap skipping should be applied to PDSCH scheduling restriction on SSB symbols outside SMTC.

Unfortunately, when multiple such scheduling restrictions are configured, there may be some ambiguity in which measurement gap or scheduling restriction is to be skipped.

Aspects of the present disclosure, however, provide mechanisms that may help remove such ambiguity. For example, in scenarios where multiple scheduling restrictions are configured, the mechanisms proposed herein may help a UE and network entity be in agreement on which of the multiple scheduling restrictions are to be skipped. As a result, aspects of the present disclosure may help provide flexibility, improve resource utilization, and improve overall performance

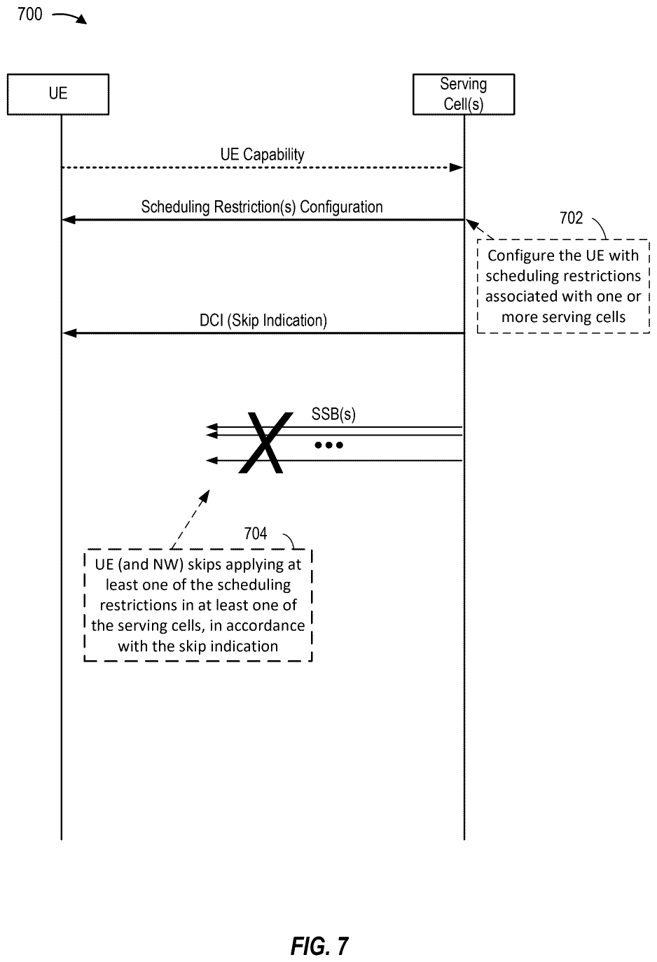

Scheduling restriction skipping proposed herein may be understood with reference to the call flow diagram 700 shown in FIG. 7.

In some aspects, the serving cell(s) shown in FIG. 7 may be an example of network entities, such as the BS depicted and described with respect to FIGS. 1 and 3 or a disaggregated base station depicted and described with respect to FIG. 2. Similarly, the UE shown in FIG. 7 may be an example of UE 104 depicted and described with respect to FIGS. 1 and 3. However, in other aspects, UE 104 may be another type of wireless communications device and BS 102 may be another type of network entity or network node, such as those described herein.

As illustrated at 702, a serving cell may configure (via first signaling) the UE with scheduling restrictions (associated with one or more of the serving cells). For example, the first signaling may be RRC signaling indicating one or more measurement gap configurations (e.g., MG patterns). In some cases, measurement gap configurations may be indicated per-UE or per-FR. In some cases, multiple concurrent measurement gap patterns may be configured. In such cases, if multiple measurement gaps overlap, gap collision resolution may be performed (e.g., based on per-gap priority).

The serving cell may transmit second signaling (e.g., a DCI) that conveys an indication that the wireless node is to skip at least one of the multiple scheduling restrictions. As illustrated at 704, the UE (and/or network entities) may skip applying at least one of the scheduling restrictions in at least one of the serving cells, in accordance with the indication.

According to certain aspects, a serving cell may configure (e.g., via RRC configuration) an MG/SR skipping indication. For example, a serving cell may be configured with (to convey) an MG/SR-skip-indication bit in DCI.

In some cases, only one serving cell may be configured to convey an MG/SR-skip-indication bit. For example, an MG/SR-skip-indication bit may be configured only on a primary cell (PCell). As another example, an MG/SR-skip-indication bit may be configured on the PCell or a primary secondary cell (PSCell), for example in an E-UTRA/NR dual connectivity (EN-DC) or NR-DC scenario. As still another example, an MG/SR-skip-indication bit may be configured on any serving cell. When an MG-skip-indication bit is configured on a PSCell or SCell, DCI-based MG skip indication may be disabled when an associated PSCell or SCell is deactivated.

According to certain aspects, multiples serving cells may be configured with an MG-skip-indication bit. In such cases, a maximum number of serving cells that can be configured with an MG-skip-indication bit may be based on a UE capability (e.g., indicated by a UE in a UE capability report).

There are various options for how a DCI format may be configured with an MG/SR-skip-indication bit. According to a first option, when an MG/SR-skip-indication bit is configured for a serving cell, the indication bit may be enabled on all DCI formats for unicast DL/UL scheduling (e.g., DCI formats 0_1, 0_2, 0_3, 1_1, 1_2, 1_3) configured on the serving cell. According to a second option, when an MG/SR-skip-indication bit is configured for a serving cell, the gNB may explicitly configure which DCI format(s) is(are) associated with the indication bit.

MG/SR skip indication may be configured for various carrier aggregation (CA) and/or dual connectivity (DC) scenarios. In such cases, an MG-skip-indication for per-UE gap can be configured on any serving cell. In some cases, an MG-skip-indication for per-FR gap may be configured only on a serving in the same FR. In other cases, an MG-skip-indication for per-FR gap may be configured on a serving in any FR.

In some cases, an (non MG involved) SR-skip-indication for an FR2 band may be configured only on a serving in the same FR2 band. In other cases, SR-skip-indication for an FR2 band may be configured on a serving in any band or FR.

In some cases, an MG/SR-skip-indication bit may be configured for both self-scheduling DCI formats and cross-carrier-scheduling (CCS) DCI formats. In the context of cross-carrier-scheduling, a serving cell may refer to a “scheduled” serving cell.

There are various options for how to determine what MG (or other SR) to skip, when a skip indication is provided (e.g., via a DCI).

For example, an MG-skip-indication bit may be applied to only measurement gaps. In some cases, a UE may skip a first (e.g., earliest occurring) measurement gap after a minimum time offset among all measurement gaps configured to the UE.

In some cases, for a serving cell configured with an MG-skip-indication bit, a gNB may configure which measurement gaps are candidate to be skipped. For example, when a measurement gap is configured (e.g., via a Rel-15 MeasGapConfig), the measurement gap to be skipped may be identified as a gap type (e.g., a UE-gap, an FR1-gap or an FR2-gap). As another example, when a measurement gap is configured (e.g., via a Rel. 17 GapConfig-r17), the measurement gap to be skipped may be identified via an ID (e.g., via a measGapId-r17).

In some cases, for a serving cell configured with an MG-skip-indication bit, a gNB may configure which measurement gaps are not candidates to be skipped.

In some cases, a gNB may indicate (e.g., via an RRC configuration for MG-skip-indication bit) which skipping mechanism is used. When multiple serving cells are configured with an MG-skip-indication bit, the different serving cells may be configured with different candidate measurement gaps to be skipped.

In some cases, collision resolution may be performed when configured measurement gaps overlap. In some cases, the measurement gap(s) to skip may be determined after collision resolution among overlapping measurement gaps. In other cases, the measurement gap(s) to skip may be determined before collision resolution is performed among overlapping measurement gaps. In other words, collision resolution may be performed after excluding skipped measurement gap(s).

Skipping indication for other types of SR skipping (e.g., other than MG skipping) may be configured via RRC configuration. For example, one serving cell in an FR2 band may be configured with an SR-skip-indication bit. If a UE is configured with serving cells in multiple FR2 bands, one serving cell in each of the FR2 bands may be configured with an SR-skip-indication bit. In such cases, a first SR-skip-indication value (e.g., of 1) may indicate a skip of the first SR after minimum time offset for all DL serving cells in the band. In some cases, such scheduling restrictions in FR2 band may or may not be associated with SMTC.

According to certain aspects, both an MG-skip-indication and an SR-skip-indication are configured on a serving cell. In some such cases, separate bits may be configured for SR-skip-indication and MG-skip-indication. In other cases, a common bit (MG-SR-skip-indication) may be configured for both MG and SR skip indication. In such cases, a first MG and/or a first SR after a minimum time offset may be skipped when skip indication is applied for both MG and SR.

According to certain aspects, a UE may signal its capability regarding support of MR and/or other types of SR skipping indications. There are various options for the granularity of such indicated UE capability.

For example, according to a first option, UE capability for MG/SR-skip-indication may be specified as a per-UE capability (e.g., indicating support across all FRs and/or bands). In such cases, a UE may indicate how many serving cells can be configured with MG/SR-skip indication.

According to a second option, UE capability for MG/SR-skip-indication may be specified with per-FR granularity. For example, when a UE is configured with FR1 CA/DC, an MG-skip-indication for a FR1-gap may be enabled when the UE indicates support for MG-skip-indication in FR1. When the UE is configured with FR2 CA/DC, an MG-skip-indication for FR2-gap or an SR-skip-indication for an FR2 band may be enabled when the UE indicates support for MG-skip-indication in FR2. When the UE is configured with FR1-FR2 CA or DC, an MG-skip-indication per-UE gap may be enabled when the UE indicates support for MG-skip-indication in FR1 and FR2.

According to a second option, UE capability for MG/SR-skip-indication may be specified with per-band granularity. For example, when a UE is configured with CA/DC in FR1, an MG-skip-indication for an FR1-gap may be enabled when the UE indicates support for MG-skip-indication in all configured FR1 bands. In some cases, when a UE is configured with CA/DC in FR2, an MG-skip-indication for an FR2-gap may be enabled when the UE indicates support for MG-skip-indication in all configured FR2 bands.

When a UE is configured with CA/DC in FR2, an SR-skip-indication for an FR2 band may be enabled when the UE indicates support for SR-skip-indication in corresponding FR2 band. When a UE is configured with FR1-FR2 CA or DC, an MG-skip-indication for per-UE gap may be enabled when the UE indicates support for MG-skip-indication in all configured FR1 and FR2 bands.

According to certain aspects, capability for cross-carrier-scheduling (in case of per-FR or per-band granularity) may be indicated. In some cases, such capability may be interpreted based on both a scheduling and a scheduled FR/band. In some cases, such capability may be interpreted based on a scheduled FR/band. In some cases, such capability may be interpreted based on a scheduling FR/band.

### Example Operations

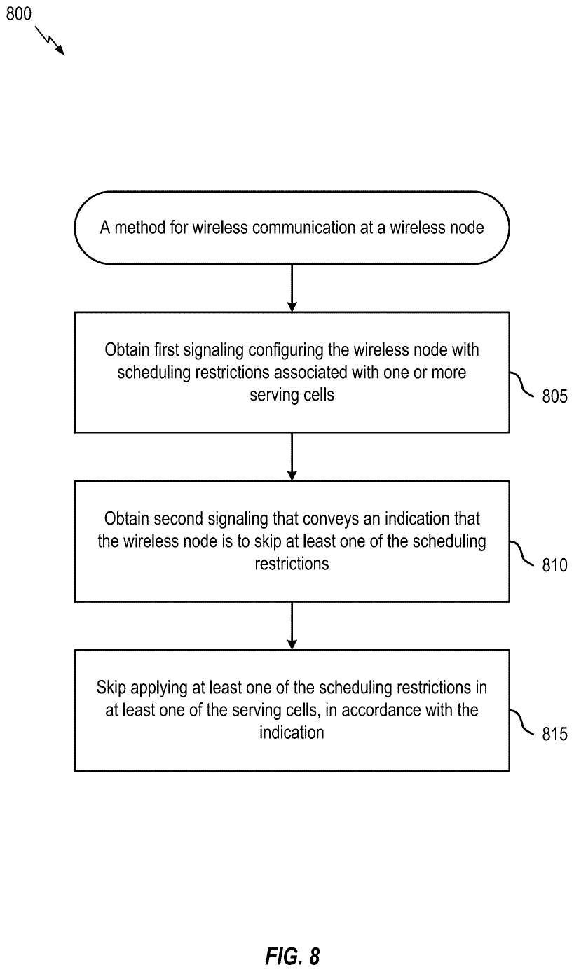

FIG. 8 shows an example of a method 800 of wireless communication at a wireless node, such as a UE 104 of FIGS. 1 and 3.

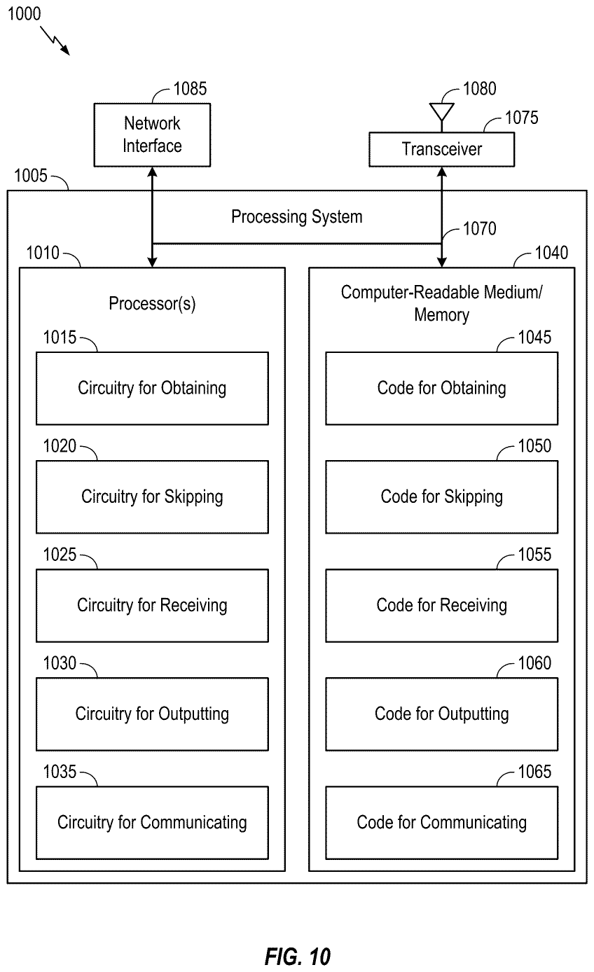

Method 800 begins at step 805 with obtaining first signaling configuring the wireless node with scheduling restrictions associated with one or more serving cells. In some cases, the operations of this step refer to, or may be performed by, circuitry for obtaining and/or code for obtaining as described with reference to FIG. 10.

Method 800 then proceeds to step 810 with obtaining second signaling that conveys an indication that the wireless node is to skip at least one of the scheduling restrictions. In some cases, the operations of this step refer to, or may be performed by, circuitry for obtaining and/or code for obtaining as described with reference to FIG. 10.

Method 800 then proceeds to step 815 with skipping applying at least one of the scheduling restrictions in at least one of the serving cells, in accordance with the indication. In some cases, the operations of this step refer to, or may be performed by, circuitry for skipping and/or code for skipping as described with reference to FIG. 10.

In some aspects, at least one of the scheduling restrictions involves avoiding communication during one or more measurement gaps (MGs) associated with one or more of the serving cells.

In some aspects, the skipping comprises at least one of: skipping at least one MG of the one or more MGs; or communicating with one or more of the serving cells during the skipped at least one MG.

In some aspects, the at least one MG comprises an MG that occurs at least a minimum time duration after obtaining the second signaling.

In some aspects, the method 800 further includes receiving third signaling indicating at least one of: a first set of the one or more MGs that are candidates for skipping, or a second set of the one or more MGs that are excluded from skipping, and wherein the at least one MG is skipped based on the third signaling. In some cases, the operations of this step refer to, or may be performed by, circuitry for receiving and/or code for receiving as described with reference to FIG. 10.

In some aspects, at least two of the one or more MGs overlap; the method further comprises performing collision resolution based on the overlap; and the at least one MG is skipped before or after performing the collision resolution.

In some aspects, at least one of the scheduling restrictions involves avoiding scheduling transmissions, associated with at least one of the serving cells, during a time duration.

In some aspects, the time duration is associated with a synchronization signal block (SSB)-based radio resource management (RRM) Measurement Timing Configuration (SMTC) window.

In some aspects, the second signaling comprises downlink control information (DCI).

In some aspects, the scheduling restrictions are associated with a first type involving measurement gaps (MGs) and a second type involving synchronization signal block (SSB)-based radio resource management (RRM) Measurement Timing Configuration SMTC windows.

In some aspects, the second signaling comprises: a first bit indicating that the wireless node is to skip at least one scheduling restriction of the first type, and a second bit indicating that the wireless node is to skip at least one scheduling restriction of the second type.

In some aspects, the second signaling comprises: a common bit indicating that the wireless node is to skip at least one of a scheduling restriction of the first type or a scheduling restriction of the second type that occurs earliest at least a minimum time duration after obtaining the second signaling.

In some aspects, the method 800 further includes outputting information indicating a capability of the wireless node to support indications to skip applying the scheduling restrictions. In some cases, the operations of this step refer to, or may be performed by, circuitry for outputting and/or code for outputting as described with reference to FIG. 10.

In some aspects, the information indicates: a quantity of serving cells for which the wireless node is capable of supporting indications to skip applying the scheduling restrictions.

In some aspects, the information indicates the capability: per frequency range, or per band.

In some aspects, the information indicates a capability of the wireless node to support indications to skip applying the scheduling restrictions conveyed via cross-carrier scheduling (CCS).

In some aspects, the method 800 further includes obtaining information regarding the second signaling. In some cases, the operations of this step refer to, or may be performed by, circuitry for obtaining and/or code for obtaining as described with reference to FIG. 10.

In some aspects, the information indicates one or more of the serving cells configured to provide the second signaling.

In some aspects, the information indicates one or more downlink control information (DCI) formats usable to provide the second signaling.

In some aspects, the one or more DCI formats support cross-carrier scheduling (CCS).

In some aspects, the information indicates at least one frequency range (FR) or frequency band via which the second signaling is obtained.

In some aspects, the scheduling restrictions are associated with a first type involving measurement gaps (MGs) and a second type involving synchronization signal block (SSB)-based radio resource management (RRM) Measurement Timing Configuration (SMTC) windows; and the information indicates 1) a first FR or frequency band via which the second signaling is obtained to skip applying scheduling restrictions of the first type and 2) a second FR or frequency band via which the second signaling is obtained to skip applying scheduling restrictions of the second type.

In one aspect, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative steps are possible consistent with this disclosure.

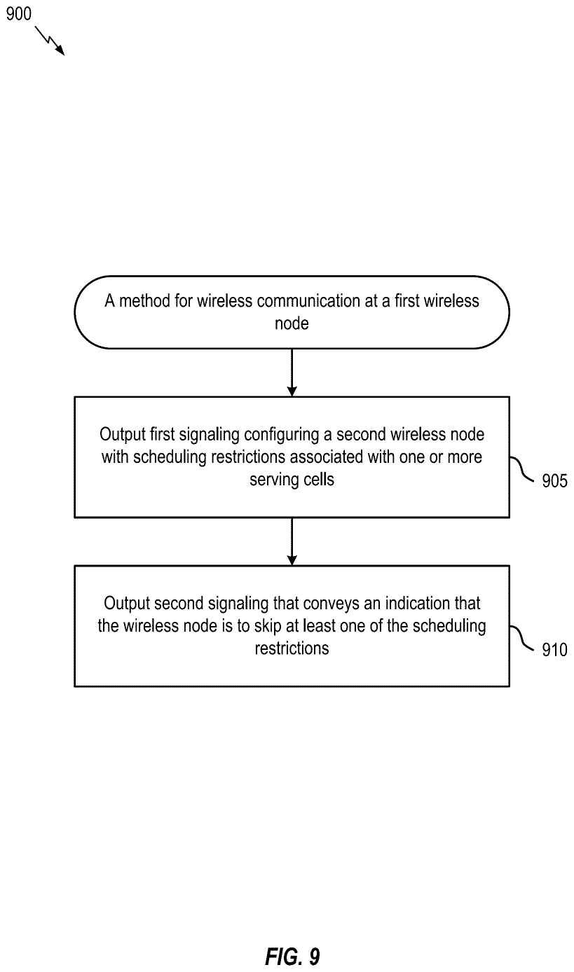

FIG. 9 shows an example of a method 900 of wireless communication at a first wireless node, such as a BS 102 of FIGS. 1 and 3, or a disaggregated base station as discussed with respect to FIG. 2.

Method 900 begins at step 905 with outputting first signaling configuring a second wireless node with scheduling restrictions associated with one or more serving cells. In some cases, the operations of this step refer to, or may be performed by, circuitry for outputting and/or code for outputting as described with reference to FIG. 10.

Method 900 then proceeds to step 910 with outputting second signaling that conveys an indication that the wireless node is to skip at least one of the scheduling restrictions. In some cases, the operations of this step refer to, or may be performed by, circuitry for outputting and/or code for outputting as described with reference to FIG. 10.

In some aspects, at least one of the scheduling restrictions involves avoiding communication during one or more measurement gaps (MGs) associated with one or more of the serving cells.

In some aspects, the method 900 further includes communicating with the second wireless node during at least one of the MGs. In some cases, the operations of this step refer to, or may be performed by, circuitry for communicating and/or code for communicating as described with reference to FIG. 10.

In some aspects, the method 900 further includes outputting third signaling indicating at least one of: a first set of the one or more MGs that are candidates for skipping, or a second set of the one or more MGs that are excluded from skipping, and wherein the at least one of the MGs is based on the third signaling. In some cases, the operations of this step refer to, or may be performed by, circuitry for outputting and/or code for outputting as described with reference to FIG. 10.

In some aspects, at least one of the scheduling restrictions involves avoiding scheduling transmissions, associated with at least one of the serving cells, during a time duration.

In some aspects, the time duration is associated with a synchronization signal block (SSB)-based radio resource management (RRM) Measurement Timing Configuration (SMTC) window.

In some aspects, the second signaling comprises downlink control information (DCI).

In some aspects, the scheduling restrictions are associated with a first type involving measurement gaps (MGs) and a second type involving synchronization signal block (SSB)-based radio resource management (RRM) Measurement Timing Configuration SMTC windows.

In some aspects, the second signaling comprises: a first bit indicating that the wireless node is to skip at least one scheduling restriction of the first type, and a second bit indicating that the wireless node is to skip at least one scheduling restriction of the second type.

In some aspects, the second signaling comprises: a common bit indicating that the wireless node is to skip at least one of a scheduling restriction of the first type or a scheduling restriction of the second type that occurs earliest at least a minimum time duration after obtaining the second signaling.

In some aspects, the method 900 further includes obtaining information indicating a capability of the second wireless node to support indications to skip applying the scheduling restrictions. In some cases, the operations of this step refer to, or may be performed by, circuitry for obtaining and/or code for obtaining as described with reference to FIG. 10.

In some aspects, the information indicates: a quantity of serving cells for which the wireless node is capable of supporting indications to skip applying the scheduling restrictions.

In some aspects, the information indicates the capability: per frequency range, or per band.

In some aspects, the information indicates a capability of the wireless node to support indications to skip applying the scheduling restrictions conveyed via cross-carrier scheduling (CCS).

In some aspects, the method 900 further includes outputting information regarding the second signaling. In some cases, the operations of this step refer to, or may be performed by, circuitry for outputting and/or code for outputting as described with reference to FIG. 10.

In some aspects, the information indicates one or more of the serving cells configured to provide the second signaling.

In some aspects, the information indicates one or more downlink control information (DCI) formats usable to provide the second signaling.

In some aspects, the one or more DCI formats support cross-carrier scheduling (CCS).

In some aspects, the information indicates at least one frequency range (FR) or frequency band via which the second signaling is output.

In some aspects, the scheduling restrictions are associated with a first type involving measurement gaps (MGs) and a second type involving synchronization signal block (SSB)-based radio resource management (RRM) Measurement Timing Configuration (SMTC) windows; and the information indicates 1) a first FR or frequency band via which the second signaling is output to skip applying scheduling restrictions of the first type and 2) a second FR or frequency band via which the second signaling is output to skip applying scheduling restrictions of the second type.

In one aspect, method 900, or any aspect related to it, may be performed by an apparatus, such as communications device 1000 of FIG. 10, which includes various components operable, configured, or adapted to perform the method 900. Communications device 1000 is described below in further detail.

Note that FIG. 9 is just one example of a method, and other methods including fewer, additional, or alternative steps are possible consistent with this disclosure.

### Example Communications Device(s)

FIG. 10 depicts aspects of an example communications device 1000. In some aspects, communications device 1000 is a user equipment, such as UE 104 described above with respect to FIGS. 1 and 3. In some aspects, communications device 1000 is a network entity, such as BS 102 of FIGS. 1 and 3, or a disaggregated base station as discussed with respect to FIG. 2.

The communications device 1000 includes a processing system 1005 coupled to the transceiver 1075 (e.g., a transmitter and/or a receiver). In some aspects (e.g., when communications device 1000 is a network entity), processing system 1005 may be coupled to a network interface 1085 that is configured to obtain and send signals for the communications device 1000 via communication link(s), such as a backhaul link, midhaul link, and/or fronthaul link as described herein, such as with respect to FIG. 2. The transceiver 1075 is configured to transmit and receive signals for the communications device 1000 via the antenna 1080, such as the various signals as described herein. The processing system 1005 may be configured to perform processing functions for the communications device 1000, including processing signals received and/or to be transmitted by the communications device 1000.

The processing system 1005 includes one or more processors 1010. In various aspects, the one or more processors 1010 may be representative of one or more of receive processor 358, transmit processor 364, TX MIMO processor 366, and/or controller/processor 380, as described with respect to FIG. 3. In various aspects, one or more processors 1010 may be representative of one or more of receive processor 338, transmit processor 320, TX MIMO processor 330, and/or controller/processor 340, as described with respect to FIG. 3. The one or more processors 1010 are coupled to a computer-readable medium/memory 1040 via a bus 1070. In certain aspects, the computer-readable medium/memory 1040 is configured to store instructions (e.g., computer-executable code) that when executed by the one or more processors 1010, cause the one or more processors 1010 to perform the method 800 described with respect to FIG. 8, or any aspect related to it; and the method 900 described with respect to FIG. 9, or any aspect related to it. Note that reference to a processor performing a function of communications device 1000 may include one or more processors 1010 performing that function of communications device 1000.

In the depicted example, computer-readable medium/memory 1040 stores code (e.g., executable instructions), such as code for obtaining 1045, code for skipping 1050, code for receiving 1055, code for outputting 1060, and code for communicating 1065. Processing of the code for obtaining 1045, code for skipping 1050, code for receiving 1055, code for outputting 1060, and code for communicating 1065 may cause the communications device 1000 to perform the method 800 described with respect to FIG. 8, or any aspect related to it; and the method 900 described with respect to FIG. 9, or any aspect related to it.

The one or more processors 1010 include circuitry configured to implement (e.g., execute) the code stored in the computer-readable medium/memory 1040, including circuitry for obtaining 1015, circuitry for skipping 1020, circuitry for receiving 1025, circuitry for outputting 1030, and circuitry for communicating 1035. Processing with circuitry for obtaining 1015, circuitry for skipping 1020, circuitry for receiving 1025, circuitry for outputting 1030, and circuitry for communicating 1035 may cause the communications device 1000 to perform the method 800 described with respect to FIG. 8, or any aspect related to it; and the method 900 described with respect to FIG. 9, or any aspect related to it.

Various components of the communications device 1000 may provide means for performing the method 800 described with respect to FIG. 8, or any aspect related to it; and the method 900 described with respect to FIG. 9, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1075 and the antenna 1080 of the communications device 1000 in FIG. 10. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1075 and the antenna 1080 of the communications device 1000 in FIG. 10.

### Example Clauses

Implementation examples are described in the following numbered clauses:
Clause 1: A method for wireless communication at a wireless node, comprising: obtaining first signaling configuring the wireless node with scheduling restrictions associated with one or more serving cells; obtaining second signaling that conveys an indication that the wireless node is to skip at least one of the scheduling restrictions; and skipping applying at least one of the scheduling restrictions in at least one of the serving cells, in accordance with the indication.
Clause 2: The method of Clause 1, wherein at least one of the scheduling restrictions involves avoiding communication during one or more measurement gaps (MGs) associated with one or more of the serving cells.
Clause 3: The method of Clause 2, wherein the skipping comprises at least one of: skipping at least one MG of the one or more MGs; or communicating with one or more of the serving cells during the skipped at least one MG.
Clause 4: The method of Clause 3, wherein: the at least one MG comprises an MG that occurs at least a minimum time duration after obtaining the second signaling.
Clause 5: The method of Clause 3, further comprising: receiving third signaling indicating at least one of: a first set of the one or more MGs that are candidates for skipping, or a second set of the one or more MGs that are excluded from skipping, and wherein the at least one MG is skipped based on the third signaling.
Clause 6: The method of Clause 3, wherein: at least two of the one or more MGs overlap; the method further comprises performing collision resolution based on the overlap; and the at least one MG is skipped before or after performing the collision resolution.
Clause 7: The method of any one of Clauses 1-6, wherein at least one of the scheduling restrictions involves avoiding scheduling transmissions, associated with at least one of the serving cells, during a time duration.
Clause 8: The method of Clause 7, wherein the time duration is associated with a synchronization signal block (SSB)-based radio resource management (RRM) Measurement Timing Configuration (SMTC) window.
Clause 9: The method of any one of Clauses 1-8, wherein the second signaling comprises downlink control information (DCI).
Clause 10: The method of any one of Clauses 1-9, wherein: the scheduling restrictions are associated with a first type involving measurement gaps (MGs) and a second type involving synchronization signal block (SSB)-based radio resource management (RRM) Measurement Timing Configuration SMTC windows.
Clause 11: The method of Clause 10, wherein the second signaling comprises: a first bit indicating that the wireless node is to skip at least one scheduling restriction of the first type, and a second bit indicating that the wireless node is to skip at least one scheduling restriction of the second type.
Clause 12: The method of Clause 10, wherein the second signaling comprises: a common bit indicating that the wireless node is to skip at least one of a scheduling restriction of the first type or a scheduling restriction of the second type that occurs earliest at least a minimum time duration after obtaining the second signaling.
Clause 13: The method of any one of Clauses 1-12, further comprising outputting information indicating a capability of the wireless node to support indications to skip applying the scheduling restrictions.
Clause 14: The method of Clause 13, wherein the information indicates: a quantity of serving cells for which the wireless node is capable of supporting indications to skip applying the scheduling restrictions.
Clause 15: The method of Clause 13, wherein the information indicates the capability: per frequency range, or per band.
Clause 16: The method of Clause 15, wherein the information indicates a capability of the wireless node to support indications to skip applying the scheduling restrictions conveyed via cross-carrier scheduling (CCS).
Clause 17: The method of any one of Clauses 1-16, further comprising obtaining information regarding the second signaling.
Clause 18: The method of Clause 17, wherein the information indicates one or more of the serving cells configured to provide the second signaling.
Clause 19: The method of Clause 17, wherein the information indicates one or more downlink control information (DCI) formats usable to provide the second signaling.
Clause 20: The method of Clause 19, wherein the one or more DCI formats support cross-carrier scheduling (CCS).
Clause 21: The method of Clause 17, wherein the information indicates at least one frequency range (FR) or frequency band via which the second signaling is obtained.
Clause 22: The method of Clause 21, wherein: the scheduling restrictions are associated with a first type involving measurement gaps (MGs) and a second type involving synchronization signal block (SSB)-based radio resource management (RRM) Measurement Timing Configuration (SMTC) windows; and the information indicates 1) a first FR or frequency band via which the second signaling is obtained to skip applying scheduling restrictions of the first type and 2) a second FR or frequency band via which the second signaling is obtained to skip applying scheduling restrictions of the second type.
Clause 23: A method for wireless communication at a first wireless node, comprising: outputting first signaling configuring a second wireless node with scheduling restrictions associated with one or more serving cells; and outputting second signaling that conveys an indication that the wireless node is to skip at least one of the scheduling restrictions.
Clause 24: The method of Clause 23, wherein at least one of the scheduling restrictions involves avoiding communication during one or more measurement gaps (MGs) associated with one or more of the serving cells.
Clause 25: The method of Clause 24, further comprising: communicating with the second wireless node during at least one of the MGs.
Clause 26: The method of Clause 25, further comprising: outputting third signaling indicating at least one of: a first set of the one or more MGs that are candidates for skipping, or a second set of the one or more MGs that are excluded from skipping, and wherein the at least one of the MGs is based on the third signaling.
Clause 27: The method of any one of Clauses 23-26, wherein at least one of the scheduling restrictions involves avoiding scheduling transmissions, associated with at least one of the serving cells, during a time duration.
Clause 28: The method of Clause 27, wherein the time duration is associated with a synchronization signal block (SSB)-based radio resource management (RRM) Measurement Timing Configuration (SMTC) window.
Clause 29: The method of any one of Clauses 23-28, wherein the second signaling comprises downlink control information (DCI).
Clause 30: The method of any one of Clauses 23-29, wherein: the scheduling restrictions are associated with a first type involving measurement gaps (MGs) and a second type involving synchronization signal block (SSB)-based radio resource management (RRM) Measurement Timing Configuration SMTC windows.
Clause 31: The method of Clause 30, wherein the second signaling comprises: a first bit indicating that the wireless node is to skip at least one scheduling restriction of the first type, and a second bit indicating that the wireless node is to skip at least one scheduling restriction of the second type.
Clause 32: The method of Clause 30, wherein the second signaling comprises: a common bit indicating that the wireless node is to skip at least one of a scheduling restriction of the first type or a scheduling restriction of the second type that occurs earliest at least a minimum time duration after obtaining the second signaling.
Clause 33: The method of any one of Clauses 23-32, further comprising obtaining information indicating a capability of the second wireless node to support indications to skip applying the scheduling restrictions.
Clause 34: The method of Clause 33, wherein the information indicates: a quantity of serving cells for which the wireless node is capable of supporting indications to skip applying the scheduling restrictions.
Clause 35: The method of Clause 33, wherein the information indicates the capability: per frequency range, or per band.
Clause 36: The method of Clause 35, wherein the information indicates a capability of the wireless node to support indications to skip applying the scheduling restrictions conveyed via cross-carrier scheduling (CCS).
Clause 37: The method of any one of Clauses 23-36, further comprising outputting information regarding the second signaling.
Clause 38: The method of Clause 37, wherein the information indicates one or more of the serving cells configured to provide the second signaling.
Clause 39: The method of Clause 37, wherein the information indicates one or more downlink control information (DCI) formats usable to provide the second signaling.
Clause 40: The method of Clause 39, wherein the one or more DCI formats support cross-carrier scheduling (CCS).
Clause 41: The method of Clause 37, wherein the information indicates at least one frequency range (FR) or frequency band via which the second signaling is output.
Clause 42: The method of Clause 41, wherein: the scheduling restrictions are associated with a first type involving measurement gaps (MGs) and a second type involving synchronization signal block (SSB)-based radio resource management (RRM) Measurement Timing Configuration (SMTC) windows; and the information indicates 1) a first FR or frequency band via which the second signaling is output to skip applying scheduling restrictions of the first type and 2) a second FR or frequency band via which the second signaling is output to skip applying scheduling restrictions of the second type.
Clause 43: An apparatus, comprising: at least one memory comprising executable instructions; and at least one processor configured to execute the executable instructions and cause the apparatus to perform a method in accordance with any combination of Clauses 1-42.
Clause 44: An apparatus, comprising means for performing a method in accordance with any combination of Clauses 1-42.
Clause 45: A non-transitory computer-readable medium comprising executable instructions that, when executed by at least one processor of an apparatus, cause the apparatus to perform a method in accordance with any combination of Clauses 1-42.
Clause 46: A computer program product embodied on a computer-readable storage medium comprising code for performing a method in accordance with any combination of Clauses 1-42.
Clause 47: A wireless node (e.g., a UE), including: at least one transceiver; at least one memory including instructions; and at least one processor configured to execute the instructions and cause the wireless node to perform a method in accordance with any combination of Clauses 1-22, wherein the at least one transceiver is configured to receive the first signaling and the second signaling.
Clause 48: A wireless node (e.g., a network entity), including: at least one transceiver; at least one memory including instructions; and at least one processor configured to execute the instructions and cause the wireless node to perform a method in accordance with any combination of Clauses 23-42, wherein the at least one transceiver is configured to transmit the first signaling and the second signaling.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

Means for obtaining, means for skipping, means for receiving, means for outputting, and means for communicating may comprise one or more processors, such as one or more of the processors described above with reference to FIG. 10.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A wireless node, comprising:
at least one transceiver;
at least one memory comprising computer-executable instructions; and
one or more processors configured to execute the computer-executable instructions and cause the wireless node to:
receive, via the at least one transceiver, first signaling configuring the wireless node with scheduling restrictions associated with one or more serving cells;
receive, via the at least one transceiver, second signaling that conveys an indication that the wireless node is to skip at least one of the scheduling restrictions; and
skip applying at least one of the scheduling restrictions in at least one of the serving cells, in accordance with the indication.

2. The wireless node of claim 1, wherein at least one of the scheduling restrictions involves avoiding communication during one or more measurement gaps (MGs) associated with one or more of the serving cells.

3. The wireless node of claim 2, wherein the skipping comprises at least one of: skipping at least one MG of the one or more MGs; or communicating with one or more of the serving cells during the skipped at least one MG.

4. The wireless node of claim 3, wherein the at least one MG comprises an MG that occurs at least a minimum time duration after obtaining the second signaling.

5. The wireless node of claim 3, wherein at least two of the one or more MGs overlap; the one or more processors are further configured to cause the wireless node to perform collision resolution based on the overlap; and the at least one MG is skipped before or after performing the collision resolution.

6. The wireless node of claim 1, wherein the second signaling comprises downlink control information (DCI).

7. The wireless node of claim 1, wherein the scheduling restrictions are associated with a first type involving measurement gaps (MGs) and a second type involving synchronization signal block (SSB)-based radio resource management (RRM) Measurement Timing Configuration SMTC windows.

8. The wireless node of claim 7, wherein the second signaling comprises: a common bit indicating that the wireless node is to skip at least one of a scheduling restriction of the first type or a scheduling restriction of the second type that occurs earliest at least a minimum time duration after obtaining the second signaling.

9. The wireless node of claim 1, wherein the one or more processors are further configured to cause the wireless node to:
receive, via the at least one transceiver, information regarding the second signaling.

10. The wireless node of claim 9, wherein the information indicates one or more of the serving cells configured to provide the second signaling.

11. The wireless node of claim 1, wherein the information indicates one or more downlink control information (DCI) formats usable to provide the second signaling.

12. A wireless node, comprising:
at least one memory comprising computer-executable instructions; and
one or more processors configured to execute the computer-executable instructions and cause the wireless node to:
transmit, via the at least one transceiver, first signaling configuring a second wireless node with scheduling restrictions associated with one or more serving cells; and
transmit, via the at least one transceiver, second signaling that conveys an indication that the wireless node is to skip at least one of the scheduling restrictions.

13. The wireless node of claim 12, wherein at least one of the scheduling restrictions involves avoiding communication during one or more measurement gaps (MGs) associated with one or more of the serving cells.

14. The wireless node of claim 12, wherein the second signaling comprises downlink control information (DCI).

15. The wireless node of claim 12, wherein the scheduling restrictions are associated with a first type involving measurement gaps (MGs) and a second type involving synchronization signal block (SSB)-based radio resource management (RRM) Measurement Timing Configuration SMTC windows.

16. The wireless node of claim 15, wherein the second signaling comprises: a common bit indicating that the wireless node is to skip at least one of a scheduling restriction of the first type or a scheduling restriction of the second type that occurs earliest at least a minimum time duration after obtaining the second signaling.

17. The wireless node of claim 12, wherein the one or more processors are further configured to cause the wireless node to:
transmit, via the at least one transceiver, information regarding the second signaling.

18. The wireless node of claim 17, wherein the information indicates one or more of the serving cells configured to provide the second signaling.

19. The wireless node of claim 17, wherein the information indicates one or more downlink control information (DCI) formats usable to provide the second signaling.

20. A method for wireless communication by a wireless node, comprising:
receiving first signaling configuring the wireless node with scheduling restrictions associated with one or more serving cells;
receiving second signaling that conveys an indication that the wireless node is to skip at least one of the scheduling restrictions; and
skipping applying at least one of the scheduling restrictions in at least one of the serving cells, in accordance with the indication.
